(19) United States
(12) Patent Application Publication
(10) Pub. No.: US 2009/0233550 A1
(43) Pub. Date: Sep. 17, 2009

(54) SERVICE CONNECTION SYSTEM AND METHOD FOR BLUETOOTH DEVICE

(75) Inventor: Byong Woo Ryu, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/402,287

(22) Filed: Mar. 11, 2009

(30) Foreign Application Priority Data
Mar. 13, 2008 (KR) 10-2008-0023300

(51) Int. Cl. H04B 7/00

(52) U.S. Cl. 455/41.2

(57) ABSTRACT

A service connection system and a method for a Bluetooth-enabled device for avoiding error caused by Hands-Free Profile (HFP) mismatch in a service level connection initialization procedure are provided. A service connection method for Bluetooth communication includes receiving, at a master device, a first command containing a first set of features supported in a slave device, extracting the first set of features from the first command, matching a second set of features with the first set of features, and transmitting a second command including the second set of features to the slave device.

### PRIORITY

This application claims the benefit under 35 U.S.C. § 119(a) of a Korean patent application filed on Mar. 13, 2008 in the Korean Intellectual Property Office and assigned Serial No. 10-2008-0023300, the entire disclosure of which is hereby incorporated by reference.

### BACKGROUND OF THE INVENTION

1. Field of the Invention

The present invention relates to a Bluetooth-enabled device. More particularly, the present invention relates to a service connection system and a method for a Bluetooth-enabled device that is capable of avoiding errors caused by Hands-Free Profile (HFP) mismatch in a service level connection initialization procedure.

2. Description of the Related Art

With functional convergence, recent mobile phones integrate various multimedia functions including MP3 file playback, digital broadcast playback and the like. In order to use the multimedia function of the mobile phone without intrusion of people in a public place, a headset (including headphone and earphone) is a useful device.

Meanwhile, the gain in popularity of mobile phones has created a demand for data exchange among the mobile phones for sharing the data. Such data communication can be implemented in various wired and wireless communication technologies. Among them, Bluetooth is a promising standard for short range wireless communication. As the Bluetooth function is becoming one of the basic functions of the mobile phone, a mobile phone can be used in conjunction with a Bluetooth-enabled headset (hereinafter called Bluetooth headset) through a Bluetooth link for voice communication and listening to music.

More particularly, the Bluetooth headset is advantageous in portability since an audio signal (including voice and other audio signals) is exchanged with the mobile phone through a cordless Bluetooth link. For this reason, the Bluetooth headset is becoming one of the most popular peripheral devices.

In order to establish a Bluetooth link, the mobile phone and Bluetooth headset first exchange their profile information. The profile information includes a Hands-Free Profile (HFP) which defines a set of functions providing interoperability between the mobile phone and the headset.

After a mobile phone and a Bluetooth headset are paired, the Bluetooth headset sends information regarding a set of functions and requests the mobile phone for its available functions.

In more detail, the HFP specifies a Service Level Connection Initialization procedure in which the devices (e.g., the mobile phone and the Bluetooth headset) exchange request and respond commands related to the functions that they each support, without a process of identifying the versions of their HFP.

In this case, when the HFP versions of the mobile phone and the Bluetooth headset differ from each other, the device supporting a lower version of the HFP does not recognize some functions of the other device supporting a higher version of the HFP.

Also, the device supporting the higher version of the HFP may not know whether the other device supports the functions of the higher version of the HFP. Accordingly, a lack of backward compatibility of conventional Bluetooth devices is likely to cause communication errors.

For example, when a Bluetooth-enabled mobile phone supporting a higher version of the HFP communicates with a Bluetooth headset supporting a lower version of the HFP, the difference between the HFP versions of the mobile phone and Bluetooth headset may result in a communication malfunction.

Therefore, a need exists for a system and method for a Bluetooth device that support different versions of Hands-Free Profile for reducing communication errors.

### SUMMARY OF THE INVENTION

An aspect of the present invention is to address at least the above-mentioned problems and/or disadvantages and to provide at least the advantages described below. Accordingly, an aspect of the present invention is to provide a service connection system and a method that is capable of reducing communication errors between Bluetooth devices supporting different versions of Hands-Free Profile.

Another aspect of the present invention is to provide a service connection system and a method for Bluetooth communication that is capable of improving backward compatibility of HFP by using Bluetooth Retrieve Supported Features (BRSF) commands.

Still another aspect of the present invention is to provide a service connection system and a method for Bluetooth communication between a Bluetooth-enabled mobile phone and a Bluetooth headset that is capable of reducing errors caused by HFP version mismatch.

Yet another aspect of the present invention is to provide a service connection system and a method for Bluetooth communication that enables Bluetooth devices supporting different HFP versions to perform BRSF command exchange in a Service Level Connection Initialization procedure by allowing devices to recognize a difference in their HFP versions and by allowing the device supporting a higher version of HFP to comply with the device supporting a lower version of HFP.

In accordance with an aspect of the present invention, a service connection method for Bluetooth communication between a master device and a slave device is provided. The method includes receiving, at a master device, a first command including a first set of features supported in the slave device, extracting the first set of features from the first command, matching a second set of features with the first set of features, and transmitting a second command including the second set of features to the slave device.

In accordance with another aspect of the present invention, a service connection method for Bluetooth communication between a master device and a slave device is provided. The method includes analyzing, at a master device, a Bluetooth Retrieve Supported Feature (BRSF) command transmitted by the slave device, verifying a first version of a profile supported in the slave device with reference to the BRSF analysis result; and transmitting a BRSF response including a modified second version of the profile in correspondence with the first version.

In accordance with still another aspect of the present invention, a service connection method for Bluetooth communication between a master device and a slave device is provided. The method includes analyzing, at a master device, a set of features of a hands-free profile received from a slave device, verifying a first version of the hands-free profile with reference to the analysis result, modifying, when the first version of the hands-free profile is lower than a second version of the hands-free profile stored in the master device, a set of features of the second version of the hands-free profile to be identical to the set of features of the first version of the hands-free profile, and transmitting the set of features of the second version of the hands-free profile to the slave device.

In accordance with yet another aspect of the present invention, a Bluetooth device is provided. The device includes a short range communication unit which establishes a radio link with another Bluetooth device for exchanging information, a storage unit which stores at least one of an application for operating functions of the device, an application and user data and at least one version of a hands-free profile, and a control unit which analyzes a Bluetooth Retrieve Supported Feature (BRSF) command received from the other Bluetooth device, modifying a version of the hands-free profile stored in the storage unit to be identical to the version of the hands-free profile included in the BRSF command, and transmits a BRSF response including the modified version of the hands-free profile to the other Bluetooth device.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a message flow diagram illustrating a Service Level Connection Establishment procedure between a mobile phone and a headset according to an exemplary embodiment of the present invention;

FIG. 2 is a flowchart illustrating a service level connection initialization procedure according to an exemplary embodiment of the present invention; and

FIG. 3 is a block diagram illustrating a configuration of a Bluetooth device according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and structures are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An exemplary embodiment of the present invention relates to a Hands-Free Profile (HFP) of Bluetooth communication. In the following, a service connection system and method for a Bluetooth link between two Bluetooth devices is provided to overcome problems caused by a lack of backward compatibility of the HFP. In the following description, the Bluetooth devices include mobile phones, a headset, and other hands-free devices supporting the HFP. The devices exchange commands for initializing service connection, i.e., Bluetooth Retrieve Supported Features (BRSF) commands for notifying devices' supported features. The BRSF commands include an Attention (AT)+BRSF command and a +BRSF which is a result code generated in response to the AT+BRSF command.

The AT+BRSF is sent by the headset to notify a mobile phone of the supported features available in the headset and request information regarding the supported features in the mobile terminal.

The +BRSF is a result code sent by the mobile phone in response to the AT+BRSF command to notify the headset of what features are supported in the mobile phone.

The HFP is a Bluetooth profile defining a set of functions such that a mobile phone may be used in conjunction with a Bluetooth-enable Bluetooth device (including hands-free device and Bluetooth headset). In this case, the headset functions as an input/output device of the mobile phone.

The devices supporting the HFP may be classified into an Audio Gateway (AG) and a Hands-Free (HF).

The AG is a device that is a gateway of an audio input and an audio output. Typical devices functioning as AGs are cellular phones. The HF is a device functioning as the AG's remote audio input and output mechanism. It also provides some remote control means. Typical devices acting as HFs are Bluetooth headsets and other Bluetooth hands-free devices.

The service connection system, according to an exemplary embodiment of the present invention, is described with reference to an HFP version mismatch scenario. In this case, it is assumed that the mobile phone supports a higher version of HFP and the hands-free device supports a lower version of HFP. Also, it is assumed that the hands-free device is a Bluetooth headset.

Table 1 and Table 2 illustrate two HFP versions supported in the mobile phone and the headset. In Table 1 and Table 2, the HFP version 1.5 and the HFP version 1.0 are compared with each other.

TABLE 1

| HFP v1.5 | | HFP v1.0 | |
|---|---|---|---|
| Bit | Feature | Bit | Feature |
| 0 | EC and/or NR function | 0 | EC and/or NR function |
| 1 | Call waiting and 3-way | 1 | Call waiting and 3-way |
| | calling | | calling |
| 2 | CLI presentation capability | 2 | CLI presentation capability |
| 3 | Voice recognition | 3 | Voice recognition |
| | activation | | activation |
| 4 | Remote volume control | 4 | Remote volume control |
| 5 | Enhanced Call Status | 5-31 | Unused |
| | | | (Shall be Initialized |
| | | | to Zero) |
| 6 | Enhanced Call Control | | |
| 7-31 | Reserved for future definition | | |
| | (Shall be initialized to Zero) | | |

TABLE 2

| HFP v1.5 | | HFP v1.0 | |
|---|---|---|---|
| Bit | Feature | Bit | Feature |
| 0 | 3-way calling | 0 | 3-way calling |
| 1 | EC and/or NR function | 1 | EC and/or NR function |
| 2 | Voice recognition function | 2 | Voice recognition function |
| 3 | In-band ring tone capability | 3 | In-band ring tone capability |
| 4 | Attach a number to a | 4 | Attach a number to a |
| | voice tag | | voice tag |
| 5 | Ability to reject a call | 5 | Ability to reject a call |
| 6 | Enhanced Call Status | 6-31 | Unused |
| | | | (Shall be initialized |
| | | | to Zero) |
| 7 | Enhanced Call Control | | |
| 8 | Extended Error Result Codes | | |
| 9-31 | Reserved for future definition | | |
| | (Shall be initialized to Zero) | | |

Table 1 lists the features of HFP v1.5 and HFP v1.0 supported in the HF, i.e. the headset, and Table 2 lists the features of HFP v1.5 and HFP v1.0 supported in the AG, i.e. the mobile phone.

In an exemplary implementation, each of the mobile phone and the headset stores both the HFPs shown in Table 1 and Table 2 that are identical in version. As aforementioned, the mobile phone supports the higher version of HFP, i.e. HFP v1.5, and the headset supports the lower version of HFP, i.e. HFP v1.0.

In this case, the mobile phone stores the features of the HFP v1.5 for HF (hereinafter called HF HFP v1.5) shown in Table 2, as well as the features of the HFP v1.5 for AG (hereinafter called AG HFP v1.5) shown in Table 1. The headset stores the features of the HFP v1.0 for AG (hereinafter called AG HFP v1.0) shown in Table 1, as well as the features of the HFP v1.0 for HF (hereinafter called HF HFP v1.0) shown in Table 2.

Accordingly, the mobile phone may verify the HFP version of the headset by comparing the values of the HF HFP version contained in the AT+BRSF command, transmitted by headset, with the values of its HF HFP version. Also, the headset may verify the HFP version of the mobile phone by comparing the values of AG HFP version contained in the +BRSF received in response to the AT+BRSF command with its AG HFP version.

From the comparison between Table 1 and Table 2, the HFP v1.5 supports additional features, i.e., an Enhanced Call Status, an Enhanced Call Control and an Extended Error Result Code, in addition to the features supported by the HFP v1.0.

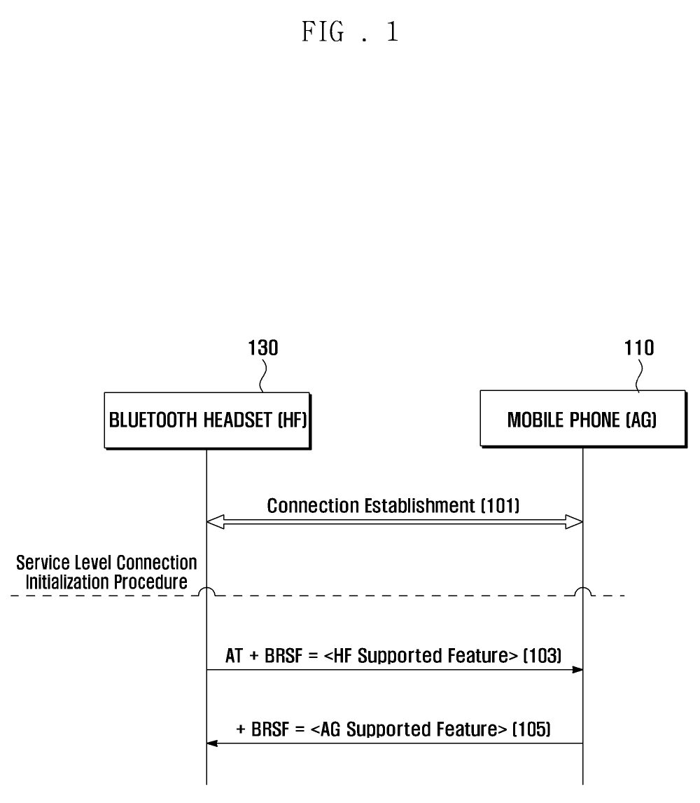

FIG. 1 is a message flow diagram illustrating a Service Level Connection Establishment procedure between a mobile phone and a headset according to an exemplary embodiment of the present invention.

In FIG. 1, the mobile phone 110 is an Audio Gateway (AG) which functions as a gateway of the audio input and the audio output, and the headset 130 is a Hands-Free (HF) which functions as a remote audio input and the audio output mechanism of the mobile phone 110. The headset 130 also provides some remote control means.

After the Bluetooth radio connection is established between the mobile phone 110 and the headset 130 in step S101, a Service Level Connection Initialization Procedure is performed between the mobile phone 110 and the headset 130.

In the Service Level Connection Initialization Procedure, the headset 130 sends a command to the mobile phone 110 to notify the mobile phone 110 of the supported features in the headset 130 in step S103.

Here, the command may be a conventional AT+BRSF command. That is, the headset 130 sends the AT+BRSF=<HF supported features> command to the mobile phone 110 to notify the mobile phone 110 of the features supported in the headset 130.

In response to the AT+BRSF command, the mobile phone 110 sends a result code to notify the headset 130 of the supported features in the mobile phone 110 in step S105.

The result code may be a conventional +BRSF result code. That is, the mobile phone 110 sends the +BRSF result code (+BRSF=<AG supported features> command) to the headset 130 to notify the headset 130 of the features supported in the mobile phone 110 in response to the AT+BRSF command.

The AT+BRSF command and +BRSF result code are 32-bit unsigned integers for indicating the features supported in the devices (the mobile phone and the headset) as shown in Table 1 and Table 2.

More particularly, the mobile phone 110 analyzes the AT+BRSF command received from the headset 130 to verify the features supported by the headset 130 and determines the features, corresponding to the features supported in the headset 130, to be notified to the headset 130. Consequently, the mobile phone 110 sends the +BRSF result code, which is generated in a modified format to indicate the features supported in the mobile phone 110, to the headset 130.

Modification of the +BRSF format is described in more detail with reference to Table 1 and Table 2.

According to a conventional HFP, the mobile phone receiving the AT+BRSF command notifies the headset of the features supported in the mobile phone by returning the +BRSF result code regardless of the HFP version of the headset. That is, the mobile phone notifies the headset of the HFP features supported in the mobile phone regardless of the HFP features supported in the headset.

In a case when the headset supporting the HFP v1.0 attempts to establish a service level connection with the mobile phone supporting the HFP v1.5 (see Table 1 and Table 2) in a conventional manner, errors may result from the connection.

For example, the Enhanced Call Status, the Enhanced Call Control and the Extended Error Result Code features of the HFP v1.5 supported in the mobile phone is not included in the HFP v1.0 supported in the headset.

In this case, the headset does not recognize the features supported by the mobile phone, which results in errors. That is, the headset does not read the bits assigned for the Enhanced Call Status, Enhanced Call Control, and Extended Error Result Code features of the 32-bit +BRSF message. Thus, execution of a corresponding process fails and results in an error.

In other words, when the two devices supporting different HFP versions attempt to establish the service level connection, the lack of backward compatibility of the HFP causes various operational problems in actual use.

The service connection system and the method according to an exemplary embodiment of the present invention overcome the problems caused by the lack of the backward compatibility between versions of HFP.

For this purpose, the mobile phone analyzes the AT+BRSF command sent by the headset to verify the HFP features supported in the headset and generates a +BRSF message with reference to the HFP features supported in the headset.

In an exemplary implementation, the headset supports HFP v1.0, the mobile phone, although it supports HFP v1.5, excludes the features that are included only in the HFP v1.5 from the +BRSF message. That is, the mobile phone modifies the +BRSF message to carry only the features that are supported in the headset.

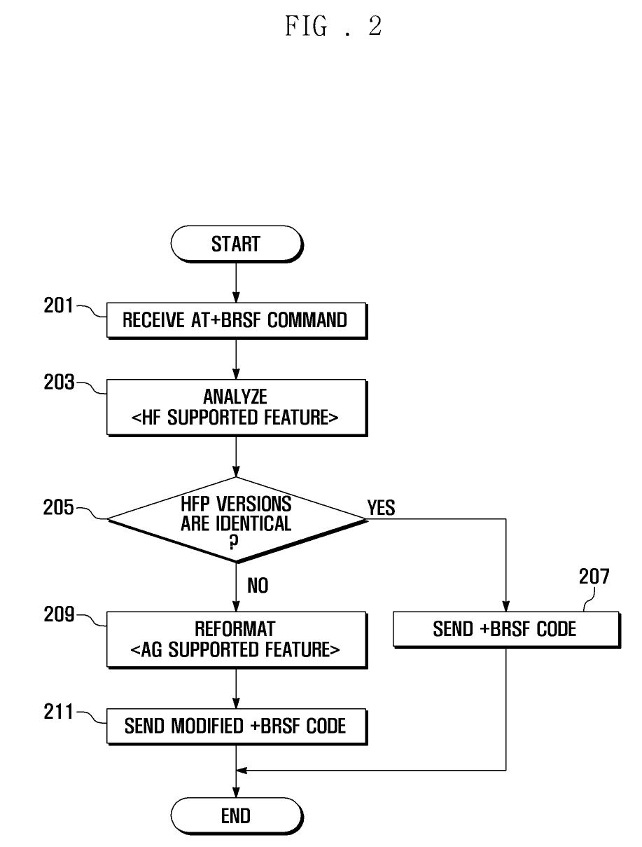

Generation of the +BRSF message is described in more detail with reference to FIG. 2 hereinafter.

FIG. 2 is a flowchart illustrating a service level connection initialization procedure according to an exemplary embodiment of the present invention.

Referring to FIGS. 1 and 2, the mobile phone 110 receives an AT+BRSF command in step S201 and analyzes the AT+BRSF command in step S203. That is, the mobile phone 110 verifies the <HF supported features> contained in the AT+BRSF command. During the analysis process, the mobile phone 110 compares the <HF supported features> of the AT+BRSF command with the <HF supported features> stored in the mobile phone 110.

The mobile phone 110 determines whether the HFP version of the headset 130 (HF HFP version) is identical to the HFP version of the mobile phone 110 (AG HFP version) with reference to the comparison result in step S205.

If the HF HFP version is identical to or higher than the AG HFP version, the mobile phone 110 sends a +BRSF message to the headset 130 in response to the AT+BRSF command in the conventional +BRSF transmission procedure in step S207.

Otherwise, if the HF HFP version is lower than the AG HFP version, the mobile phone 110 reformats the +BRSF message such that the +BRSF message indicates the HFP features corresponding to the HF HFP version in step S209.

Referring to Table 1 and Table 2, the mobile phone 110 resets the 6^{th} to 31^{st} bits of the <AG Supported features> code to zero to exclude the features of the Enhanced Call Status, the Enhanced Call Control and the Extended Error Result Code indicated by the 6^{th} to 8^{th} bits of the <AG HFP Supported Features> code from the +BRSF message.

In this manner, the mobile phone 110 creates the <AG Supported Features> code corresponding to the <HF Supported Features> code.

After creating the <AG Supported Features> code, the mobile phone 110 sends the +BRSF message containing the <AG Supported Features> code to the headset 130 in step S211.

Although a service level connection initialization procedure is described in which the mobile phone supports a higher HFP version than the HFP version of the headset, the present invention is not limited thereto. For example, in an exemplary implementation, a hands-free device may support a higher HFP version than the HFP version of the mobile phone.

In the above exemplary embodiment of the present invention, the headset sends the AT+BRSF command and the mobile phone responds to the AT+BRSF command with the +BRSF result code. However, the present invention is not limited thereto. For example, Bluetooth devices may be classified into a master device and slave device such that the slave device sends the AT+BRSF command and the master device sends the +BRSF result code to the slave device in response to the AT+BRSF command.

In this case, the master device may be any of the devices sending the +BRSF code in response to an AT+BRSF command sent by another device in the Service Level Connection Initialization procedure. Also, the slave device may be any of the devices (including mobile phones) that send the AT+BRSF command to the other device.

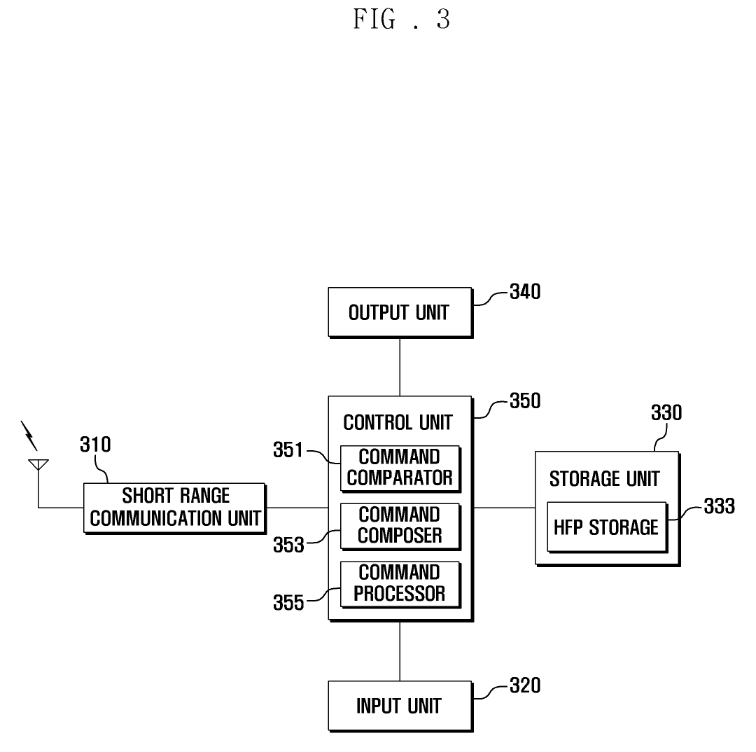

FIG. 3 is a block diagram illustrating a configuration of a Bluetooth device according to an exemplary embodiment of the present invention.

The device may be any one of a master device and a slave device supporting the short range communication. Accordingly, the master device and the slave device may include the same structure. Therefore, each device may be either a master or a slave, depending on its roll.

Referring to FIG. 3, the Bluetooth device includes a short range communication unit 310, an input unit 320, a storage unit 330, an output unit 340 and a control unit 350. The control unit 350 includes a command comparator 351, a command composer 353 and a command processor 355. The storage unit 330 includes an HFP storage 333.

The short range communication unit 310 is responsible for short range radio communication of the device. That is, the short range communication unit 310 establishes a radio link with another device for exchanging signals to perform a specific function. The short range communication unit 310 may be implemented with any one of a Bluetooth module, an Infrared Data Association (IrDA) module, a ZigBee module and other types of short range communication modules. In an exemplary implementation, it is assumed that the short range communication unit 310 is a Bluetooth module. The devices receive the AT+BRSF command and send the +BRSF code by means of the short range communication unit 310, when a Service Level Connection Initialization procedure is performed between the devices.

The input unit 320 is provided with a plurality of alphanumeric keys for inputting alphanumeric data and a plurality of functions keys for configuring and executing various functions of the device. The input unit 320 transfers the signals corresponding to the keys to the control unit 350. The input unit 320 may be implemented with at least one of a touchpad, a keypad and a touchscreen. The input unit 320 may be omitted according to the type of device used for communication.

The storage unit 330 stores at least one application program, and data and user data input by a user. The storage unit 330 may include one or more buffers for buffering the data generated by the at least one application program. The storage unit 330 includes the HFP storage 333 which stores the HFP supported in the device. More particularly, the storage unit 330 stores at least one different version of the HFP as well as the device's HFP.

The at least one application program may include an HFP comparison application for comparing the slave device's<HF Supported Features> of the AT+BRSF command with the master device's<HF Supported Features> stored in the device, a reformat application for creating the master device's<AG Supported Features> in correspondence with the slave device's<HF Supported Features> and a +BRSF generation application for generating the +BRSF code carrying the <AG Supported Features> and transmitting the +BRSF code to the slave device.

The output unit 340 is responsible for output of the device. The output unit 340 may be implemented with a display panel for displaying visual information and an audio procession module for outputting audible information through a speaker (SPK), depending on the type of device used for communication.

The control unit 350 controls operations of the device and signaling among internal components of the device. That is, the control unit 350 controls the signaling among the short range communication unit 310, input unit 320, storage unit 330 and output unit 340. The control unit 350 may include a data processing unit (not shown) having a codec and a modem.

More particularly, the control unit 350 analyzes the AT+BRSF command received from the slave device, verifies the features supported in the slave device with reference to the analysis result and determines the features coded into the +BRSF code to be transmitted to the slave device. The HFP features to be coded into the +BRSF code are determined as a result of comparison between the <HF Supported Features> of the AT+BRSF command and <HF Supported Features> stored in the HFP storage 333 (see Table 1 and Table 2). The control unit 350 also generates the +BRSF command encoded with the <AG Supported Features> and sends the +BRSF code encoded with the <AG Supported Features> to the slave device.

That is, when the slave device supports the HFP version that is lower than the version of the HFP supported in the master device, the control unit 350 of the master device creates the <AG Supported Features> by reformatting the <HF Supported Features>. In detail, reformatting the <HF Supported Features> is that excludes the features that are supported by the master device but not supported by the slave device in master device's the <HF Supported Features>. The control unit 350 sends the +BRSF code encoded with the <AG Supported Features> to the slave device.

In order to perform the service level connection initialization procedure in the above-described manner, the control unit 350 includes the command comparator 351, the command composer 353 and the command processor 355. These components may be implemented in the form of software modules.

In order to improve control efficiency, the control unit 350 is provided with the command comparator 351 for comparing the <HF Supported Features> of the AT+BRSF command received from the slave device with the <HF Supported Features> stored in the master device, the command composer 353 for creating an <AG Supported Features> to be in correspondence with the <HF Supported Features> of the AT+BRSF command and the command processor 355 for generating a +BRSF code encoded with the <AG Supported Features> and sends the +BRSF code to the slave device.

Although depicted with simplified components associated with the present invention, in FIG. 3, the structure of the device is not limited thereto. For example, the device may include any one of a Radio Frequency (RF) unit, a digital broadcast unit and an Internet access module. Also, some of the internal components of the device may be omitted or replaced with other equivalent components according to an operation type of the device.

As described above, the service connection system and method for a Bluetooth device according to an exemplary embodiment of the present invention avoids errors that may occur in the service level connection initialization procedure between the devices supporting different profile versions.

Also, the service connection system and method for a Bluetooth device according to an exemplary embodiment of the present invention improves backward compatibility of a hands-free profile of a Bluetooth protocol. Accordingly, malfunctions caused by an HFP version mismatch are reduced.

Also, the service connection system and method for a Bluetooth device according to exemplary embodiments of the present invention enables a master device to modify a +BRSF code, which is sent in response to an AT+BRSF command transmitted by a slave device, to comply with the HFP version supported in the slave device. Accordingly, errors caused by an HFP version mismatch are reduced.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A service connection method for Bluetooth communication between a master device and a slave device, the method comprising:
receiving, at a master device, a first command comprising a first set of features supported in a slave device;
extracting the first set of features from the first command;
matching a second set of features with the first set of features; and
transmitting a second command comprising the second set of features to the slave device.

2. The service connection method of claim 1, wherein the matching of the second set of features with the first set of features comprises:
comparing the first set of features with the second set of features; and
nullifying the features of the second set that are comprised in the first set of features.

3. The service connection method of claim 1, wherein the first command comprises a Bluetooth Retrieve Supported Feature (BRSF) command notifying the master device of the features supported in the slave device, and the second command comprises a BRSF command notifying the slave device of the features supported in the master device.

4. The service connection method of claim 1, wherein the second set of features are matched with the first set of features when a version of at least one of the first set of features and the second set of features are different from each other.

5. A service connection method for Bluetooth communication between a master device and a slave device, the method comprising:
analyzing, at a master device, a Bluetooth Retrieve Supported Feature (BRSF) command transmitted by a slave device;
verifying a first version of a profile supported in the slave device with reference to the BRSF analysis result; and
transmitting a BRSF response comprising a modified second version of the profile in correspondence with the first version.

6. The service connection method of claim 5, wherein the verifying of the first version of a profile supported in the slave device comprises comparing the first version of the profile with a second version of the profile stored in the master device.

7. The service connection method of claim 6, wherein the comparing of the first version of the profile with a second version of the profile comprises comparing a set of features of the first version of the profile and a set of features of the second version of the profile.

8. The service connection method of claim 7, wherein the profile comprises a hands-free profile, and the first version of the profile and the second version of the profile are at least one of identical with each other and different from each other.

9. The service connection method of claim 6, wherein the verifying of the first version of the profile supported in the slave device further comprises modifying, when the first version of the profile is lower than the second version of the profile, the second version of the profile features to be identical to the features of the first version of the profile.

10. The service connection method of claim 9, wherein the modifying of the second version of the profile comprises matching the features of the modified second version of the profile with the features of the first version of the profile.

11. The service connection method of claim 10, further comprising encoding the modified second version of the profile into the BRSF response.

12. A service connection method for Bluetooth communication between a master device and a slave device, the method comprising:
analyzing, at a master device, a set of features of a hands-free profile received from a slave device;
verifying a first version of the hands-free profile with reference to the analysis result;
modifying, when the first version of the hands-free profile is lower than a second version of the hands-free profile stored in the master device, a set of features of the second version of the hands-free profile to be identical to the set of features of the first version of the hands-free profile; and
transmitting the set of features of the second version of the hands-free profile to the slave device.

13. The service connection method of claim 12, wherein the set of features of the first version of the hands-free profile is transmitted by a Bluetooth Retrieve Supported Feature (BRSF) command.

14. The service connection method of claim 13, wherein the modifying of the set of features of the second version of the hands-free profile comprises nullifying features not comprised in the first version of the hands-free profile.

15. The service connection method of claim 14, wherein the nullifying of the features not comprised in the first version of the hands-free profile comprises setting bits corresponding to the features to zero.

16. A Bluetooth device comprising:
a short range communication unit for establishing a radio link with another Bluetooth device for exchanging information;
a storage unit for storing at least one of an application for operating functions of the device, an application and user data and at least one version of a hands-free profile; and
a control unit for analyzing a Bluetooth Retrieve Supported Feature (BRSF) command received from the other Bluetooth device, modifying a version of the hands-free profile stored in the storage unit to be identical to the version of the hands-free profile comprised in the BRSF command, and transmitting a BRSF response comprising the modified version of the hands-free profile to the other Bluetooth device.

17. The Bluetooth device of claim 16, wherein the at least one application comprises;
a version comparison application for comparing the version of the hands-free profile comprised in the BRSF command and the hands-free profile stored in the storage unit;
a reformat application for reformatting the version of the hands-free profile stored in the storage to be identical to the version of the hands-free profile comprised in the BRSF command; and
a BRSF generation application for generating a BRSF response indicating features of the reformatted version of the hands-free profile and transmitting the BRSF response to the other Bluetooth device.

18. The Bluetooth device of claim 16, wherein the storage unit stores a version of the hands-free profile supported in the Bluetooth device and at least one different version of the hands-free profile supported in the other Bluetooth device.

19. The Bluetooth device of claim 16, wherein the control unit transmits, when the version of the hands-free profile supported in the other Bluetooth device is lower than the version of the hands-free profile supported in the Bluetooth device, the BRSF response, which excludes features that are not supported in the other Bluetooth device.

20. The Bluetooth device of claim 19, wherein the control unit comprises:
a command comparator for comparing the version of the hands-free profile comprised in the BRSF command and the version of the hands-free profile stored in the storage unit;
a command composer for reformatting the version of the hands-free profile stored in the storage to be identical to the version of the hands-free profile comprised in the BRSF command; and
a command processor for generating a BRSF response indicating features of the reformatted version of the hands-free profile and transmitting the BRSF response to the other Bluetooth device.
